(19) United States
(12) Patent Application Publication
(10) Pub. No.: US 2014/0192557 A1
(43) Pub. Date: Jul. 10, 2014

(54) EDGE-LIT BACKLIGHT MODULE

(71) Applicant: UNITY OPTO TECHNOLOGY CO., LTD., NEW TAIPEI CITY (TW)

(72) Inventors: KO-WEI LU, NEW TAIPEI CITY (TW); WEI-CHUNG LIN, NEW TAIPEI CITY (TW); CHUN-HUNG CHEN, NEW TAIPEI CITY (TW); JONG-WOEI WHANG, NEW TAIPEI CITY (TW); SHIH-MIN CHAO, NEW TAIPEI CITY (TW); GUAN-WEI CHEN, NEW TAIPEI CITY (TW); YU-HAN HO, NEW TAIPEI CITY (TW); YING-CHIA CHEN, NEW TAIPEI CITY (TW)

(73) Assignee: UNITY OPTO TECHNOLOGY CO., LTD., NEW TAIPEI CITY (TW)

(21) Appl. No.: 13/773,815

(22) Filed: Feb. 22, 2013

(30) Foreign Application Priority Data
Jan. 8, 2013 (TW) 102100534

(51) Int. Cl. G09F 13/14

(52) U.S. Cl. CPC G09F 13/14
USPC 362/612

(57) ABSTRACT

Disclosed is an edge-lit backlight module having a rectangular back panel with a reflective microstructure, and a first light portion with an inclined plane or a camber is provided for reflecting lights emitted from a plurality of LEDs and with a relatively smaller normal included angle, and a second light portion is provided for reflecting a light with a slightly greater included angle, and a third light portion is provided for reflecting the light with the greatest included angle to guide lights of different intensities to different paths and project the lights to every position of a front panel, so as to achieve a light extraction efficiency with a uniform distribution of luminous intensity of an LED light source.

### CROSS-REFERENCE TO RELATED APPLICATIONS

This non-provisional application claims priority under 35 U.S.C. §119(a) on Patent Application No(s). 102100534 filed in Taiwan, R.O.C. on Jan. 8, 2013, the entire contents of which are hereby incorporated by reference.

### BACKGROUND OF THE INVENTION

1. Field of the Invention

The present invention relates to the field of backlight modules of display devices, and more particularly to an edge-lit backlight module of a structure without a light guide plate and capable of providing a light extraction efficiency with a uniform distribution of luminous intensity of an LED light on a light exit surface.

2. Description of the Related Art

Since liquid crystal display (LCD) is a passive display device without any self-luminous function, therefore it is necessary to additionally install a backlight module to provide a light source required for the display of a front panel. The factor whether or not a surface light source produced by the backlight module has sufficient uniform brightness affects the display quality of LCD directly. At present, the backlight module is divided according to its structure into two types, respectively: an edge-light backlight module and a direct backlight module respectively, wherein the edge-lit backlight module is designed by using a light source with edge incident light, and it features a light weight, a narrow frame and a low power consumption, so that the edge-lit backlight module is applied extensively in middle and small-sized LCDs below 18″ inches.

In addition, the LED has the features of high light emitting efficiency, long service life, and low power consumption, and becomes the best choice of a light source applied in the backlight module. The conventional edge-lit backlight module comprises a plurality of LED light sources arranged in a matrix and installed on two opposite sides of a back panel respectively, and a light guide plate covered onto the back panel for guiding and changing a light path, so that the lights emitted from the LED light source are emitted uniformly to overcome the problem of the high directivity. However, the light guide plate acting as a light guide medium absorbs lots of light energy that affects the light emitting efficiency. To meet requirements of large display devices, the light guide plate comes with a large area and thus increases the weight and cost of the display devices. Further, a light guide plate with a thin structure incurs a relatively high manufacturing cost due to its difficult manufacturing process.

Therefore, it is a main subject of the present invention to overcome the aforementioned structural design of the back panel and skip or replace the light guide plate while maintaining a planar uniform light extraction efficiency.

### SUMMARY OF THE INVENTION

In view of the problems of the prior art, it is a primary objective of the present invention to provide an edge-lit backlight module by a low manufacturing cost, and the edge-lit backlight module adopts a reflective microstructure of a back panel to guide lights of different intensities to different paths to achieve a uniform light illumination effect.

To achieve the aforementioned objective, the present invention provides an edge-lit backlight module comprising a back panel in a rectangular shape, a plurality of LEDs and a front panel, wherein the LEDs are symmetrically arranged on two opposite sides of the back panel respectively, and the front panel is covered onto the back panel and the LEDs, and a light path of an emitted light of each LED and a normal forms an included angle between 0°˜90° which can be divided sequentially into a first angular zone, a second angular zone and a third angular zone, such that lights emitted from the LEDs are projected directly and reflected from the back panel onto the front panel to provide a light extraction efficiency with a uniform luminous intensity, characterized in that the back panel has a first light portion, a second light portion and a third light portion sequentially arranged from the center position of the back panel towards two opposite sides of the back panel, and the first light portion, the second light portion and the third light portion are inclined planes or cambers for reflecting light in the first angular zone, light in the second angular zone and light in the third angular zone respectively.

Provided that the first light portion, the second light portion and the third light portion are inclined planes and have a first slope m1, a second slope m2 and a third slope m3 respectively, the first slope m1 has an absolute value within a range of 0.01˜1.00 slope unit to reflect the light in the first angular zone, and the second slope m2 has an absolute value within a range of 0.01˜0.50 slope unit to reflect the light in the second angular zone, and the third slope m3 has an absolute value within a range of 0.01˜1.20 slope unit to reflect the light in the third angular zone.

Provided that the first light portion, the second light portion and the third light portion are circular cambers and have a first radius r1, a second radius r2 and a third radius r3 respectively, and the first radius r1 falls within a range of 5˜70 mm to reflects the light in the first angular zone, and the second radius r2 falls within a range of 10˜80 mm to reflect the light in the second angular zone, and the third radius r3 falls within a range of 20˜125 mm to reflect the light in the third angular zone.

Provided that the first light portion, the second light portion and the third light portion are parabolic cambers and have a first focal length c1, a second focal length c2 and a third focal length c3 respectively, the first focal length c1 falls within a range of 3699˜1304 mm to reflect the light in the first angular zone, and the second focal length c2 falls within a range of 3699˜1635 mm to reflect the light in the second angular zone, and the third focal length c3 falls within a range of 3699˜847.5 mm to reflect the light in the third angular zone.

Provided that the first light portion, the second light portion and the third light portion are elliptical cambers and have a first long axis a1 and a first short axis b1, a second long axis a2 and a second short axis b2 and a third long axis a3 and a third short axis b3 respectively, the first long axis a1 equals to 3.9 mm and the first short axis b1 falls within a range of 0.18˜1.27 mm to reflect the light in the first angular zone, and the second long axis a2 equals to 10 mm and the second short axis b2 falls within a range of 0.01˜0.18 mm to reflect the light in the second angular zone, and the third long axis a3 equals to 20 mm and the third short axis b3 falls within a range of 0.01˜10 mm to reflect the light in the third angular zone.

Wherein, when the back panel is divided from a center line into left and right sides, the first light portion and the second light portion on a side are tilted in a same tilt direction and opposite to the tilt direction of the third light portion. The front panel includes a baffle installed on two opposite sides of the front panel separately and made of plastic, black paint, light absorbent tape or metal. The baffle is perpendicularly extended towards the back panel to form a blocking portion for blocking an emitted light of the LED directly projected on the front panel. The back panel has a reflective plate attached thereon and made of polyethylene terephthalate (PET) or metal, or the back panel has a reflective layer formed by a vapor deposition of metal for enhancing the reflectivity of emitted lights of the LEDs and the reflection of the emitted lights of the LEDs to improve the light emitting efficiency.

The edge-lit backlight module further comprises a light guide film covered onto the back panel and disposed under the front panel for enhancing the guidance of a light path of the emitted lights of the LEDs to distribute the luminous intensity uniformly, and the light guide film has a plurality of cylindrical microstructures formed on an upper surface of the light guide film and a plurality of triangular pyramid microstructures formed on a lower surface of the light guide film, and the light guide film comprises four optical films stacked on one another, and one or more of the optical films are brightness enhancement film(s) and diffusion film(s).

Therefore, the light source of each LED is projected directly or reflected from the reflective microstructure of the back panel, so that lights of different intensities show light paths with different distances to achieve the light extraction efficiency of lights with a uniform luminous intensity on the light exit surface. The present invention replaces the conventional backlight module or a light guide plate used in a planar light source and adopts brightness enhancement films to lower the manufacturing cost and improve the light emitting efficiency effectively.

### BRIEF DESCRIPTION OF THE DRAWINGS

FIG. 1 is a schematic view of a radiation pattern of an LED of a preferred embodiment of the present invention;

FIG. 2 is a perspective view of a first implementation mode of a preferred embodiment of the present invention;

FIG. 3 is a cross-sectional view of a second implementation mode of a preferred embodiment of the present invention;

FIG. 4 is a cross-sectional view of a third implementation mode of a preferred embodiment of the present invention;

FIG. 5 is a cross-sectional view of a fourth implementation mode of a preferred embodiment of the present invention;

FIG. 6 is a cross-sectional view of a fifth implementation mode of a preferred embodiment of the present invention;

FIG. 7 is a schematic view of VESA FPDM 2.0 illumination measurement; and

FIG. 8 is a cross-sectional view of a sixth implementation mode of a preferred embodiment of the present invention.

### DETAILED DESCRIPTION OF THE PREFERRED EMBODIMENTS

The technical content of the present invention will become apparent with the detailed description of preferred embodiments and the illustration of related drawings as follows.

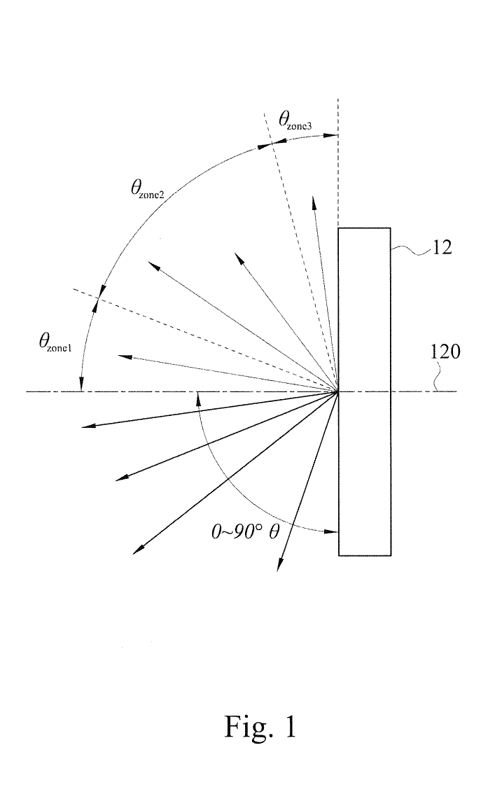

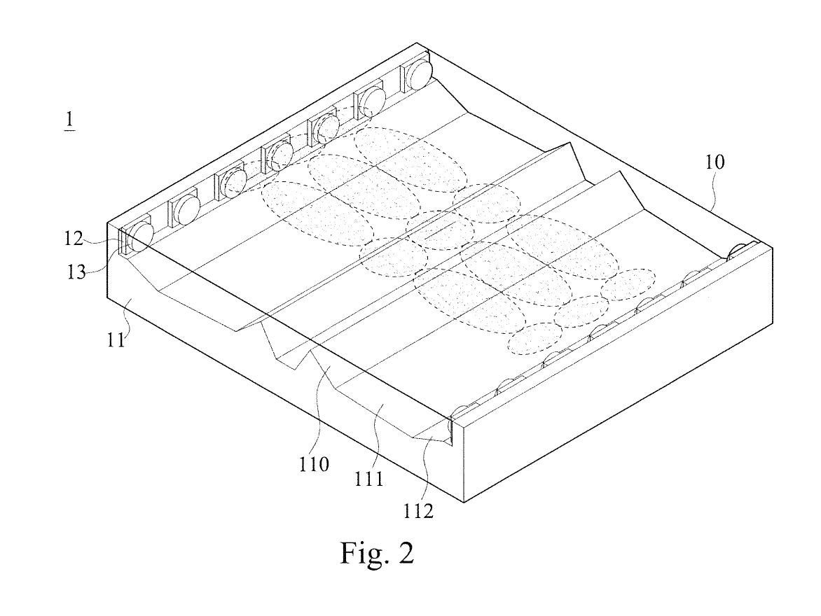

With reference to FIGS. 1 and 2 for a schematic view of a radiation pattern of an LED and a perspective view of an edge-lit backlight module in accordance with a preferred embodiment of the present invention respectively, the edge-lit backlight module 1 comprises a rectangular front panel 10, a back panel 11, a plurality of LEDs 12 and a plurality of lenses 13, wherein the LEDs 11 are symmetrically arranged on two opposite sides of the back panel 11, and the lenses 13 are installed corresponding to the LEDs 12, and the front panel 10 is covered onto the back panel 11 and the LEDs 12. The back panel 11 has a first light portion 110, a second light portion 111 and a third light portion 112 arranged sequentially from the center position of the back panel 11 towards two opposite sides of the back panel 11 and having an inclined plane or a camber to form a reflective structure, such that lights emitted from the LEDs 12 are projected directly and reflected from the reflective structure to provide a light extraction efficiency of the light with a uniform luminous intensity on the front panel 10. Since the light path of the light emitted from each LED 12 and the center position of a normal form an included angle θ of 0°˜90°, therefore the included angle from 0° to 90° can be divided sequentially into a first angular zone θ_{zones1} a second angular zone θ_{zone2} and a third angular zone θ_{zone3}. From the feature of the high directivity of the LED 11, we know that the light in the first angular zone θ_{zone1} has relatively higher energy, and the light in the second angular zone θ_{zone2} comes next, and the light in the third angular zone θ_{zone3} comes last.

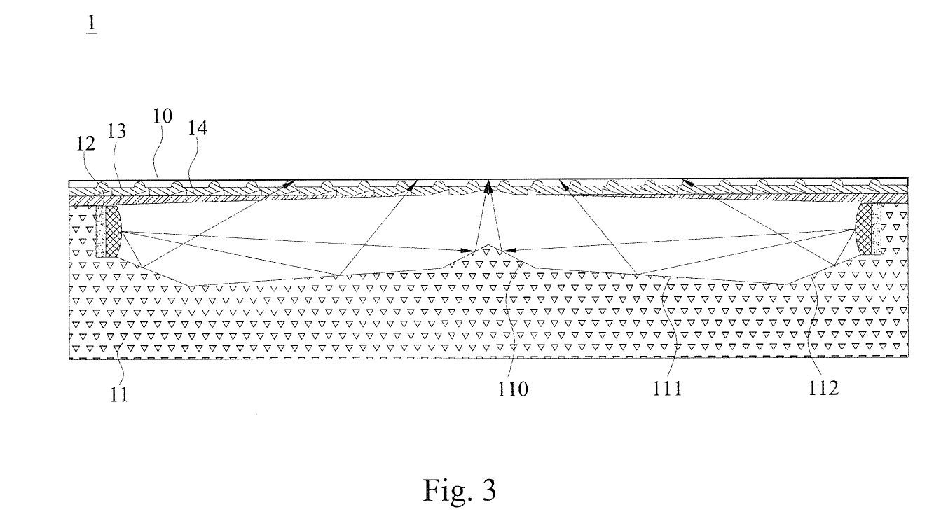

The edge-lit backlight module 1 having the back panel 11 with the dimensions (length×width×height) equal to 228 mm×150 mm×1.5 mm and 24 pieces of 6015 LEDs 12 installed on both sides of the back panel 11 is used as an example. The first light portion 110, the second light portion 111 and the third light portion 112 have inclined planes with a first slope m1, a second slope m2 and a third slope m3 respectively as shown in FIG. 3. When the back panel 11 is divided from a center line into symmetrical left and right sides, the first light portions 110 are coupled to form a point of inflection due to the opposite tilt directions, and each of the second light portions 111 and each of the first light portions 110 have the same tilt direction, but opposite to the tilt direction of each of the third light portions 112. The first slope m1 has an absolute value within a range of 0.01˜1.00 slope unit for reflecting the light emitted from the LED 12 in the first angular zone θ_{zone1}; the second slope m2 has an absolute value within a range of 0.01˜0.50 slope unit for reflecting the light in the second angular zone θ_{zone2}; and the third slope m3 has an absolute value within a range of 0.01˜1.20 slope unit for reflecting the light in the third angular zone θ_{zone3}. Through the light portions 110, 111, 112 of different inclinations, lights with high, middle and low energy emitted from the LEDs 12 can be projected uniformly onto every position of the front panel 10 to improve the uniformity of the light exit plane, and achieve the expected brightness without increasing the light emitting power of each LED 12, so as to achieve the effect of lowering the manufacturing cost.

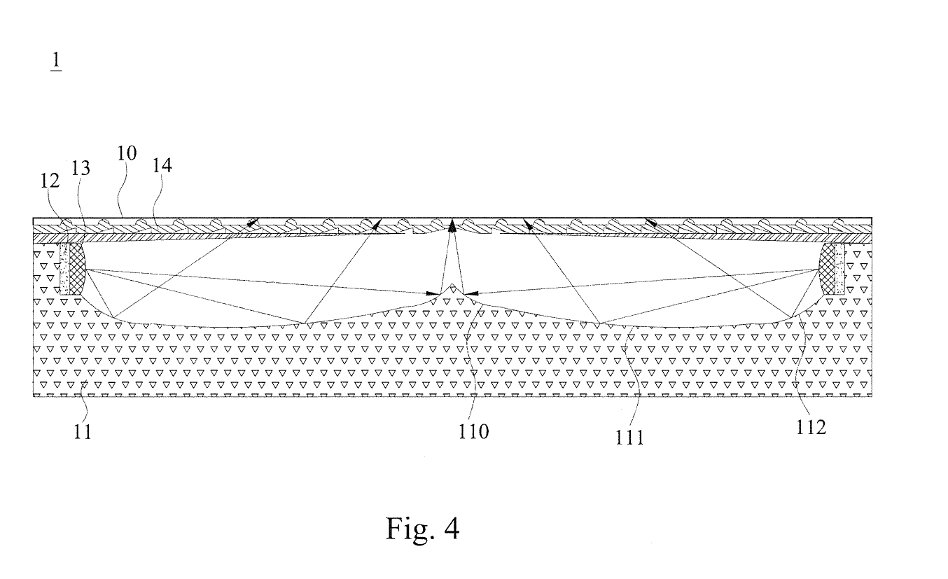

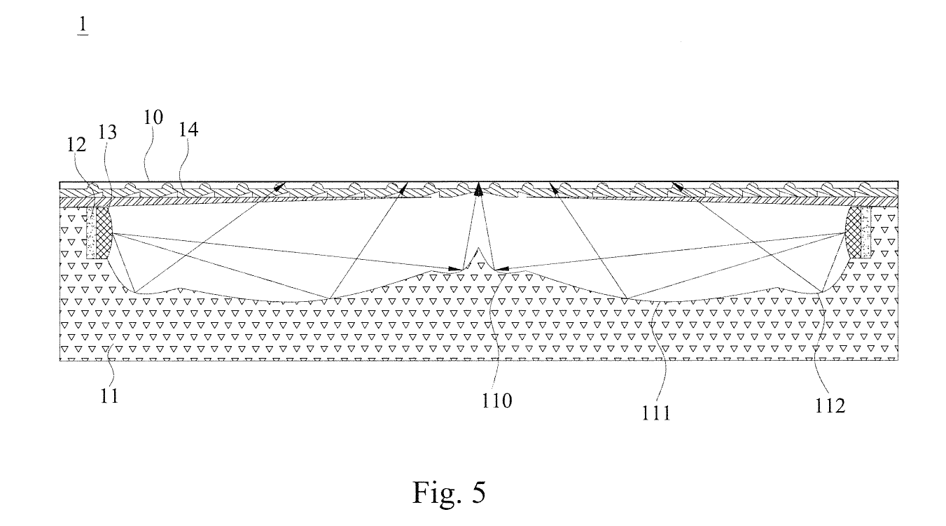

In FIG. 4, the first light portion 110, the second light portion 111 and the third light portion 112 can be circular cambers having a first radius r1, a second radius r2 and a third radius r3 respectively, wherein the first radius r1 falls within a range of 5˜70 mm for reflecting the light in the first angular zone θ_{zone1}; the second radius r2 falls within a range of 10˜80 mm for reflecting the light in the second angular zone θ_{zone2}; and the third radius r3 falls within a range of 20˜125 mm for reflecting the light in the third angular zone θ_{zone3}. In FIG. 5, the first light portion 110, the second light portion 111 and the third light portion 112 can be parabolic cambers having a first focal length c1, a second focal length c2 and a third focal length c3 respectively, wherein the first focal length c1 falls within a range of 3699˜1304 mm for reflecting the light in the first angular zone θ_{zone1}, the second focal length c2 falls within a range of 3699˜1635 mm for reflecting the light in the second angular zone θ_{zone2}; and the third focal length c3 falls within a range of 3699˜847.5 mm for reflecting the light in the third angular zone θ_{zone3}.

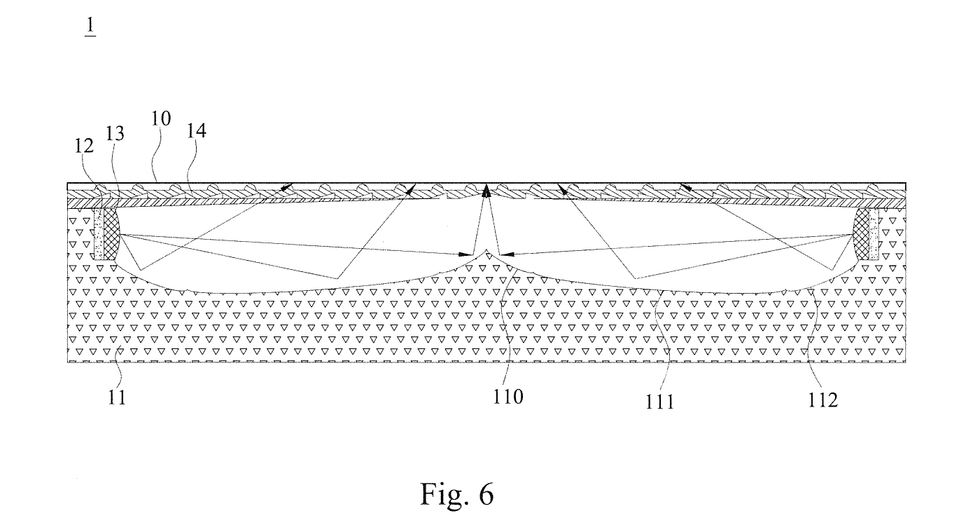

In FIG. 6, the first light portion 110, the second light portion 111 and the third light portion 112 can be elliptical cambers having a first long axis a1 and a first short axis b1, a second long axis a2 and a second short axis b2 and a third long axis a3 and a third short axis b3, wherein the first long axis a1 equals to 3.9 mm and the first short axis b1 falls within a range of 0.18˜1.27 mm for reflecting the light in the first angular zone θ_{zone1}; the second long axis a2 equals to 10 mm and the second short axis b2 falls within a range of 0.01˜0.18 mm for reflecting the light in the second angular zone θ_{zone2}; and the third long axis a3 equals to 20 mm and the third short axis b3 falls within a range of 0.01˜10 mm for reflecting the light in the third angular zone θ_{zone3}.

The back panel 11 has a reflective plate attached thereon and made of PET or metal such as silver or the back panel 11 has a reflective layer formed by a vapor deposition of a metal such as aluminum for enhancing the reflection of emitted lights of the LEDs 12 to improve the light emitting efficiency. In addition, the edge-lit backlight module 1 having the LEDs 12 on both sides may cause a too-strong luminous intensity at the two opposite sides due to the direct illumination of the lights emitted from the LEDs 12, so that the front panel 10 has a baffle 15 installed on two opposite sides of the front panel separately and made of plastic, black paint, light absorbent tape or metal such as silver.

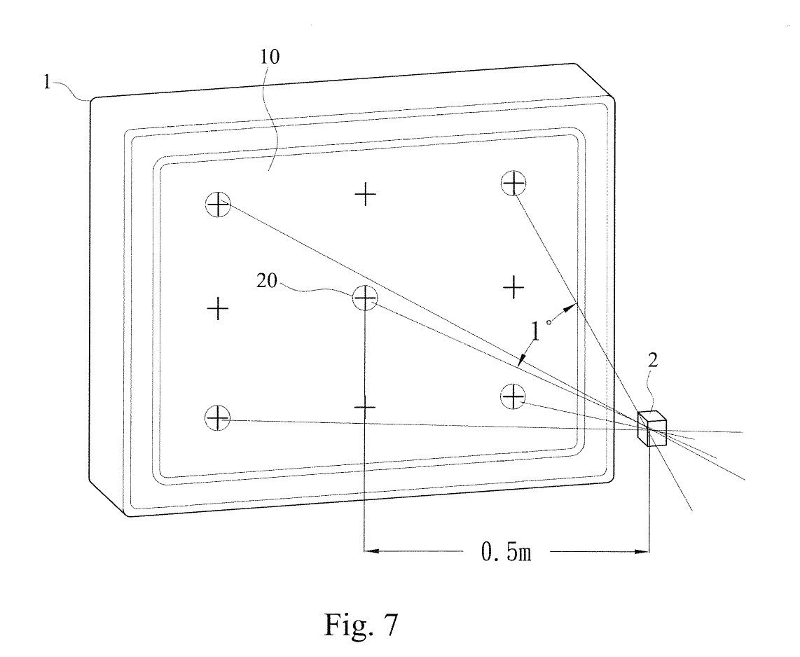

According to the Flat Panel Display Measurement Standard (FPDM) 2.0 set by the Video Electronics Standards Association (VESA), measurements are taken as shown in FIG. 7, wherein the distance between the front panel 10 and a measuring device 2 equal to 0.5 m is used for measuring nine positions on the front panel 10, and an area with light projected at a solid angle of 1° and the brightness at the center are used to obtain the uniformity. Compared with the conventional maximum brightness 300 nits, a 10″ backlight module with 36 pieces of 6015 LEDs and a power of 2.3 W at the fifth measuring point 20 has a brightness of 4,100 cd/m₂ and a uniformity of 65%. On the other hand, the edge-lit backlight module 1 of the present invention has the 25-mm metal baffles 15 installed on both sides and having a power of 7.1 W, and a brightness of 7,000 cd/m₂ and a uniformity of 64% at the fifth measuring point as shown in Table 1. The edge-lit backlight module 1 of the present invention has the same uniformity of the conventional 10″ backlight module, but the brightness is much greater than the actual requirement, so that after the power is reduced to 3.6 W, the measurements of the brightness and the uniformity same as the conventional ones can be obtained. Obviously, the present invention can achieve the effects of improving the light emitting efficiency while reducing the power consumption and lowering the cost of the product.

TABLE 1

| | | Item | | | |
|---|---|---|---|---|---|
| | | 6015LED | | | |
| | | QTY. | Power consumption | Brightness | Uniformity |
| | | Unit | | | |
| | | Piece | W | cd/m² | % |
| 10″ backlight module | | 36 | 2.3 W = 120 mA * 19.2 V | 4,100 | 65 |
| | | | (6S/6P) | | |
| Edge-lit | Baffle 25 mm | 48 | 7.1 W = 150 mA * 47 V | 7,100 | 64 |
| backlight | | | (8S/6P) | | |
| module | Baffle 25 mm | 48 | 3.6 W = 80 mA * 45.9 V | 4,100 | 62 |
| | | | (8S/6P) | | |
| | Baffle 25 mm + | 48 | 3.6 W = 80 mA * 45.9 V | 4,500 | 77 |
| | Light guide | | (8S/6P) | | |
| | film 0.3 mm | | | | |
| | Baffle 12.5 mm + | 48 | 3.6 W = 80 mA * 45.9 V | 4,500 | 68 |
| | Light guide | | (8S/6P) | | |
| | film 0.3 mm | | | | |

Note:
1) S, Series circuit
2) P, Parallel circuit

To enhance the guidance of the light path of the emitted lights of the LEDs 12, the front panel 10 has a light guide film 14 of 0.3 mm disposed under the front panel 10 and covered onto the back panel 11, a plurality of cylindrical microstructures formed on an upper surface of the light guide film 14 and a plurality of triangular pyramid microstructures formed on a lower surface of the light guide film 14, so that the triangular pyramid microstructures are used to achieve the full reflection effect and reflect lights from different angles to the top and pass through the cylindrical microstructures to the outside for a uniform illumination, so that the edge-lit backlight module 1 at the fifth measuring point has a brightness of 4,500 cd/m₂ and a uniformity of 77% and enhance the uniformity of the luminous intensity significantly.

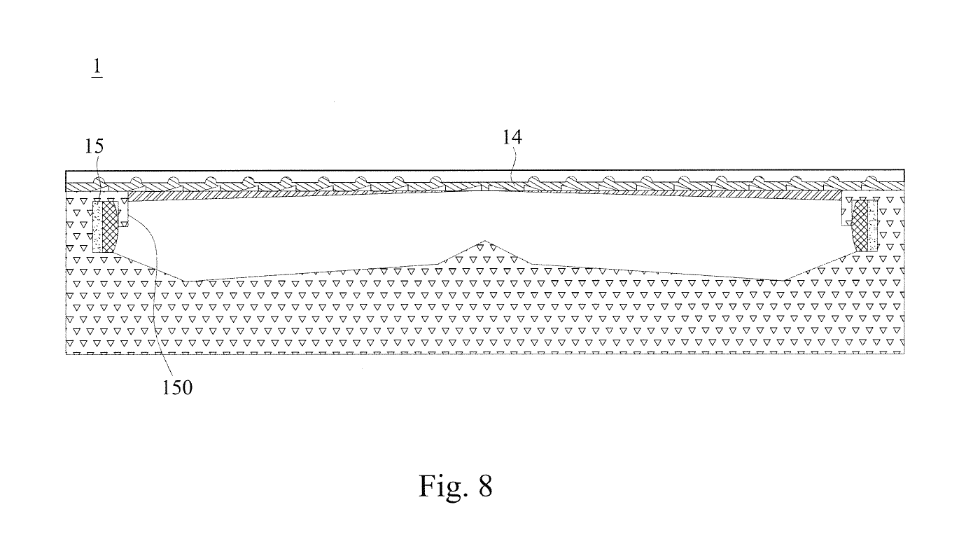

On the other hand, the use together with the light guide film 14, the increase of the light exit area of the front panel 10 as much as possible and the reduction of the baffles from 15 mm to 12.5 mm allow the edge-lit backlight module 1 to have a brightness of 4,500 cd/m₂ and a uniformity of 68%. In view of the description above, the LEDs 12 project the emitted lights to the front panel 10 directly to cause too-great brightness on both sides of the front panel 10 which is unfavorable to the overall uniformity at the light exit surface. To overcome such problem, the baffle 15 has a blocking portion 150 perpendicularly extended towards the back panel 11 as shown in FIG. 8, or the upper half of the lens 13 is coated with black paint for blocking the emitted lights of the LEDs 12 passing through the upper half of the lens 13 and projecting onto the front panel 10.

It is noteworthy that the light guide film 14 is formed by four optical films stacked on one another, and one or more of the optical films are brightness enhancement film(s) and diffusion film(s). To overcome the too-bright illumination at the center and reduce the height of the triangular pyramid microstructures, the cylindrical microstructures at the center position of the light guide film 14 can be removed. Based on the principle of the dot light source, small sized LEDs 12 are used, and the angle of the lens 13 is turned to increase the energy projected onto the light guide film 14 to improve the uniformity while reducing the number of LEDs 12 used.

What is claimed is:

1. An edge-lit backlight module, comprising a back panel in a rectangular shape, a plurality of light emitting diodes (LEDs) and a front panel, wherein the LEDs are symmetrically arranged on two opposite sides of the back panel, and the front panel is covered on the back panel and the LEDs, and a light path of an emitted light of each LED and a normal form an included angle between 0°˜90° which is divided sequentially into a first angular zone, a second angular zone and a third angular zone, such that lights emitted from the LEDs are projected directly and reflected from the back panel onto the front panel to provide a light extraction efficiency with a uniform luminous intensity, characterized in that the back panel has a first light portion, a second light portion and a third light portion sequentially arranged from a center position of the back panel towards two opposite sides of the back panel, and the first light portion, the second light portion and the third light portion are inclined planes or cambers for reflecting light in the first angular zone, light in the second angular zone and light in the third angular zone respectively.

2. The edge-lit backlight module of claim 1, wherein when the back panel is divided from a center line into left and right sides respectively, the first light portion and the second light portion on a side are tilted in a same tilt direction and opposite to a tilt direction of the third light portion.

3. The edge-lit backlight module of claim 1, wherein when the first light portion, the second light portion and the third light portion are inclined planes and have a first slope m1, a second slope m2 and a third slope m3 respectively, the first slope m1 has an absolute value within a range of 0.01˜1.00 slope unit to reflect the light in the first angular zone, and the second slope m2 has an absolute value within a range of 0.01˜0.50 slope unit to reflect the light in the second angular zone, and the third slope m3 has an absolute value within a range of 0.01˜1.20 slope unit to reflect the light in the third angular zone.

4. The edge-lit backlight module of claim 3, wherein when the back panel is divided from a center line into left and right sides respectively, the first light portion and the second light portion on a side are tilted in a same tilt direction and opposite to a tilt direction of the third light portion.

5. The edge-lit backlight module of claim 1, wherein when the first light portion, the second light portion and the third light portion are circular cambers and have a first radius r1, a second radius r2 and a third radius r3 respectively, and the first radius r1 falls within a range of 5˜70 mm to reflects the light in the first angular zone, and the second radius r2 falls within a range of 10˜80 mm to reflect the light in the second angular zone, and the third radius r3 falls within a range of 20˜125 mm to reflect the light in the third angular zone.

6. The edge-lit backlight module of claim 5, wherein when the back panel is divided from a center line into left and right sides respectively, the first light portion and the second light portion on a side are tilted in a same tilt direction and opposite to a tilt direction of the third light portion.

7. The edge-lit backlight module of claim 1, wherein when the first light portion, the second light portion and the third light portion are parabolic cambers and have a first focal length c1, a second focal length c2 and a third focal length c3 respectively, the first focal length c1 falls within a range of 3699˜1304 mm to reflect the light in the first angular zone, and the second focal length c2 falls within a range of 3699˜1635 mm to reflect the light in the second angular zone, and the third focal length c3 falls within a range of 3699˜847.5 mm to reflect the light in the third angular zone.

8. The edge-lit backlight module of claim 7, wherein when the back panel is divided from a center line into left and right sides respectively, the first light portion and the second light portion on a side are tilted in a same tilt direction and opposite to a tilt direction of the third light portion.

9. The edge-lit backlight module of claim 1, wherein when the first light portion, the second light portion and the third light portion are elliptical cambers and have a first long axis a1 and a first short axis b1, a second long axis a2 and a second short axis b2 and a third long axis a3 and a third short axis b3 respectively, the first long axis a1 equals to 3.9 mm and the first short axis b1 falls within a range of 0.18˜1.27 mm to reflect the light in the first angular zone, and the second long axis a2 equals to 10 mm and the second short axis b2 falls within a range of 0.01˜0.18 mm to reflect the light in the second angular zone, and the third long axis a3 equals to 20 mm and the third short axis b3 falls within a range of 0.01˜10 mm to reflect the light in the third angular zone.

10. The edge-lit backlight module of claim 9, wherein when the back panel is divided from a center line into left and right sides respectively, the first light portion and the second light portion on a side are tilted in a same tilt direction and opposite to a tilt direction of the third light portion.

11. The edge-lit backlight module of claim 1, wherein the back panel has a reflective plate attached thereon and made of polyethylene terephthalate (PET) or metal, or the back panel has a reflective layer formed by a vapor deposition of metal for enhancing the reflection of emitted lights of the LEDs.

12. The edge-lit backlight module of claim 1, wherein the front panel includes a baffle installed on two opposite sides of the front panel separately and made of plastic, black paint, light absorbent tape or metal.

13. The edge-lit backlight module of claim 12, wherein the baffle is perpendicularly extended towards the back panel to form a blocking portion for blocking emitted lights of the LEDs directly projected on the front panel.

14. The edge-lit backlight module of claim 1, further comprising a light guide film covered onto the back panel and disposed under the front panel for enhancing the guidance of the light path of the emitted lights of the LEDs to further improve the light extraction efficiency with the uniform luminous intensity, and the light guide film has a plurality of cylindrical microstructures formed on an upper surface of the light guide film and a plurality of triangular pyramid microstructures formed on a lower surface of the light guide film, and the light guide film comprises four optical films stacked on one another, and the optical films are at least one selected from the group consisting of a brightness enhancement film, a diffusion film or a combination thereof
